(19) United States
(12) Patent Application Publication
(10) Pub. No.: US 2007/0104444 A1
(43) Pub. Date: May 10, 2007

(54) Method of stretching optical fiber base material and stretching apparatus

(76) Inventors: Shinji Suzuki, Ibaraki-ken (JP); Waichi Yamamura, Gunma-ken (JP)

Correspondence Address: CLARK & BRODY, 1090 VERMONT AVENUE, NW, SUITE 250, WASHINGTON, DC, 20005, US

(21) Appl. No.: 10/582,016

(22) PCT Filed: Dec. 2, 2004
(86) PCT No.: PCT/JP04/17918

§ 371 Date: Jun. 7, 2006

(30) Foreign Application Priority Data
Dec. 9, 2003 (JP) 2003-410700

(51) Int. Cl. G02B 6/00

(52) U.S. Cl. 385/134

(57) ABSTRACT

A stretching method and apparatus of an optical fiber base material including gripping both ends in a longitudinal direction of an optical fiber base material by a pair of gripping devices, and, while pulling the optical fiber base material by moving one or both of the pair of the gripping devices in a first direction parallel to the longitudinal direction, moving a heating device relative to the optical fiber base material in a second direction opposite to the first direction, wherein stretch of the optical fiber base material is performed while changing the relative moving speed Vb(x) in accordance with expression (1):
Vb·[Dₘₐₓ/D(x)]²≦Vb(x)≦Vb·[Dₘₐₓ/D(x)]³ (1)
where Vb represents a reference speed, Dₘₐₓ represents a maximum outer diameter of the optical fiber base material, D(x) represents an outer diameter at a heated position x of the optical fiber base material, and Vb(x) represents a relative moving speed of the heating device relative to the optical fiber base material at the heated position x.

### TECHNICAL FIELD

The present invention relates to a stretching method of an optical fiber base material for stretching the optical fiber base material to a desired outer diameter while heating and softening it, and to a stretching apparatus used for implementing the method.

### BACKGROUND ART

An optical fiber is manufactured by drawing an optical fiber base material (preform). The preform is obtained by subjecting an optical fiber base material (starting base material) having an outer diameter whose variation in the longitudinal direction is relatively large to a stretching processing in which it is stretched to a desired outer diameter while being heated and softened. As a heating means, a heating burner flame using a fuel gas such as oxygen, hydrogen and methane, an electric furnace using a resistor heater or the like are used.

In recent years, there is a tendency to use a large starting base material for the purpose of improving productivity of the optical fiber. However, in the case of a starting base material having an outer diameter larger than 100 mm, since a heating means with a large heating power is needed, it is difficult to use a heating burner as the heating means. Accordingly, an electric furnace having a resistor hearer or the like is used in most cases.

However, the size accuracy of an optical fiber base material, or preform obtained by a stretching processing using an electric furnace having a large heat zone is worse than that obtained by a stretching processing using a heating burner.

For this reason, an optical fiber base material having been stretched by use of an electric furnace as the heating means has large variation in its outer diameter size in the longitudinal direction. Accordingly, in most cases, after the stretch processing using an electric furnace, a finish stretch processing by use of a small heating means, for example, a small-sized heating burner (fuel gas: oxygen, hydrogen, methane, etc.) or a small-sized electric furnace is performed in order to avoid problems from occurring in a final drawing processing.

### DISCLOSURE OF THE INVENTION

### Problems to be Solved by the Invention

When a starting material large in outer diameter is stretched and manufactured, and there is therefore variation in the outer diameter size in the longitudinal direction, for example, when an electric-furnace-stretch base material is subjected to a finish stretch processing at a subsequent step, the optical fiber base material is heated by a heating means moving at a constant speed in the longitudinal direction of the base material with a constant supply amount of heat per unit time in conventional stretching methods. However, in such a conventional finish stretch processing, it could occur that application of heat to the base material becomes insufficient at a portion where the diameter is large, and the base material is broken because the base material is not softened sufficiently. It could also occur that a pulling force becomes extremely large at a maximum outer diameter portion of the base material, and stretch equipment is damaged. Furthermore, it could occur that a portion at which the outer diameter is small is heated more than necessary, adversely affecting an outer diameter control.

For this reason, previously, optical fiber base materials with large outer diameter variation have been rejected as defective products without subjecting them to the finish stretch processing. This has been a cause of lowering the manufacturing yield.

The present invention has been made to remove the above problems, and the object thereof is to provide a stretching method of an optical fiber base material and a stretching apparatus used for implementing the method, which make it possible to reduce the variation of the diameter size in the longitudinal direction when the optical fiber base material has been stretched, to thereby improve the manufacturing yield. Also, the object is to provide a stretching method of an optical fiber base material and a stretching apparatus used for implementing the method which can perform the finish stretch processing on an electric-furnace-stretch optical fiber having a tendency to have large outer diameter size variation in the longitudinal direction when processed by the conventional method.

### Means for Solving Problem

The method of the present invention is a stretching method of an optical fiber base material including the steps of:

gripping both ends in a longitudinal direction of an optical fiber base material by a pair of gripping devices; and

while pulling the optical fiber base material by moving one or both of the pair of the gripping devices in a first direction parallel to the longitudinal direction, moving a heating device relative to the optical fiber base material in a second direction opposite to the first direction;

wherein stretch of the optical fiber base material is performed while changing the relative moving speed Vb(x) in accordance with expression (1):
Vb·[Dₘₐₓ/D(x)]²≦Vb(x)≦Vb·[Dₘₐₓ/D(x)]³ (1)
where Vb represents a reference speed, Dₘₐₓ represents a maximum outer diameter of the optical fiber base material, D(x) represents an outer diameter at a heated position x of the optical fiber base material, and Vb(x) represents a relative moving speed of the heating device relative to the optical fiber base material at the heated position x.

Preferred aspects of the above described stretching method of the optical fiber base material are as the following (A) to (H), however it is possible to combine two or more of them in some cases.

(A) The above described stretching method in which the outer diameter of the optical fiber base material is measured over the longitudinal direction thereof in advance of the stretching, and the stretching of the base material is performed while changing the relative moving speed of the heating device relative to the fiber base material on the basis of results of the measurement.

(B) The above described stretching method in which a pulling speed of the optical fiber base material is set within a range satisfying the following expression (2):
0.5≦(Dt/Dₘₐₓ)²≦0.99 (2)
where Dt is a target stretched outer diameter, and Dₘₐₓ is the same as the meaning defined in the expression (1).

(C) The above described stretching method in which the heating device is a burner, and a point at which a center line of the heating burner nozzle crosses at right angles with an axial line of the optical fiber base material lies in a position distant by 0 to 50 mm in the second direction from a position at which the outer diameter of the optical fiber base material starts changing due to heat application by the heating burner.

(D) The above described stretching method in which a combustion gas used in the heating device is oxygen, and a flammable gas is hydrogen or propane.

(E) The above described stretching method in which the heating device is an electric furnace, the electric furnace is disposed in parallel with the longitudinal direction of the optical fiber base material, and a point at which a center of the heating burner in the longitudinal direction crosses at right angles with an axial line of the optical fiber base material lies in a position distant by 0 to 50 mm in the second direction from a position at which the outer diameter of the optical fiber base material starts changing due to heat application by the electric furnace.

(F) The above described stretching method in which the relative speed is a relative speed created by fixing one of the pair of the gripping devices, and moving the heating device in the second direction.

(G) The above described stretching method in which the relative speed is a relative speed created by moving both of the pair of the gripping devices at different speeds in the first direction, and fixing the heating device.

(H) The above described stretching method in which the relative speed is a relative speed created by moving both of the pair of the gripping devices at different speeds in the first direction, and moving the heating device in the second direction.

The present invention also provides a stretching apparatus of an optical fiber base material comprising:

a pair of gripping devices for gripping both ends in a longitudinal direction of the optical fiber base material;

a heating device for heating a periphery of the optical fiber base material;

a gripping device moving device for moving one or both of the pair of the gripping devices to pull the optical fiber base material in a first direction parallel to the longitudinal direction; and

an arithmetic and control unit;

wherein the arithmetic and control unit performs an arithmetic and control with a target moving speed at a heated position of the optical fiber base material being set to the relative moving speed of the heating device relative to the optical fiber base material, and when the relative moving speed is Vb(x), Vb(x) is changed in accordance with expression (1):
Vb·[Dₘₐₓ/D(x)]²≦Vb(x)≦Vb·[Dₘₐₓ/D(x)]³ (1)
where Vb represents a reference speed, Dₘₐₓ represents a maximum outer diameter of the optical fiber base material, D(x) represents an outer diameter of the optical fiber base material at the heated position x, and Vb(x) represents the relative moving speed of the heating device relative to the optical fiber base material at the heated position x.

Preferred aspects of the above described stretching apparatus of the optical fiber base material are as the following (a) to (i), however it is possible to combine two or more of them in some cases.

(a) The above described stretching apparatus further comprising an outer diameter measuring device for measuring an outer diameter at each position in the longitudinal direction of the optical fiber base material.

(b) The above described stretching apparatus in which the arithmetic and control unit also computes a pulling speed of the optical fiber on the basis of the outer diameter at each position in the longitudinal direction of the optical fiber base material, and the gripping device moving device moves one or both of the pair of the gripping devices on the basis of the results.

(c) The above described stretching apparatus in which the pulling speed of the optical fiber is set within a range satisfying the following expression (2):
0.5≦(Dt/Dₘₐₓ)²≦0.99 (2)
where Dt is a target stretched outer diameter, and Dₘₐₓ is the same as the meaning defined in the expression (1).

(d) The above described stretching apparatus in which, in a case where the both of the pair of the gripping devices are pulled, the gripping devices at the both ends in the longitudinal direction are moved by the gripping device moving device at different speeds so that the optical fiber base material is pulled in the first direction.

(e) The above described stretching apparatus in which the heating device is a heating burner.

(f) The above described stretching apparatus in which the heated position lies in a position distant by 0 to 50 mm in the relative moving direction of the heating burner relative to the optical fiber base material from a position at which the outer diameter of the optical fiber base material starts changing due to heat application by the heat burner.

(g) The above described stretching apparatus in which a combustion gas used in the heating device is oxygen, and a flammable gas is hydrogen or propane.

(h) The above described stretching apparatus in which the heating device is an electric resistor furnace.

(i) The above described stretching apparatus further comprising a heating device moving device for moving the heating device in a second direction opposite to the first direction.

### Effect of the Invention

In the stretching method and the stretching apparatus according to the present invention, the relative moving speed of the heating device relative to the optical fiber base material is controlled depending on the variation of the outer diameter size (cross sectional area) of the optical fiber base material before stretched. Accordingly, it becomes possible to supply a sufficient amount of heat by more reducing the moving speed of the heating device at a large outer diameter portion of the optical fiber base material, and to avoid the optical fiber base material from being heated more than necessary by more increasing the moving speed of the heating device at a small outer diameter portion, which enables stretching the optical fiber base material to a desired outer diameter or a diameter accurately. Also, the present invention enables reducing consumption of time required of the stretch processing and gas, which contributes to cost reduction.

Also, the present invention enables finish-stretch-processing a large-sized optical fiber base material having a maximum outer diameter larger than 100 mm, and large variation in outer diameter in the longitudinal direction, to make a preform with a uniform outer diameter.

Accordingly, the manufacturing cost of an optical fiber can be reduced.

Also, according to the present invention, it becomes possible to stretch an optical fiber base material without applying an excessive load to stretching equipment. Accordingly, it becomes possible to perform finish stretch processing on even optical fiber base materials with large outer diameter variations that have been rejected as defective products, to thereby improve the manufacturing yield.

Furthermore, with the stretching apparatus of the present invention, there is no fear that stretching becomes impossible due to insufficient heating unlike conventional stretching apparatuses, because it is possible to supply heat to each portion of the optical fiber base material by an amount needed for the stretching, even when the stretching is performed by moving the heating burner from the side of a thin diameter portion to the side of a thick diameter portion of the optical fiber base material.

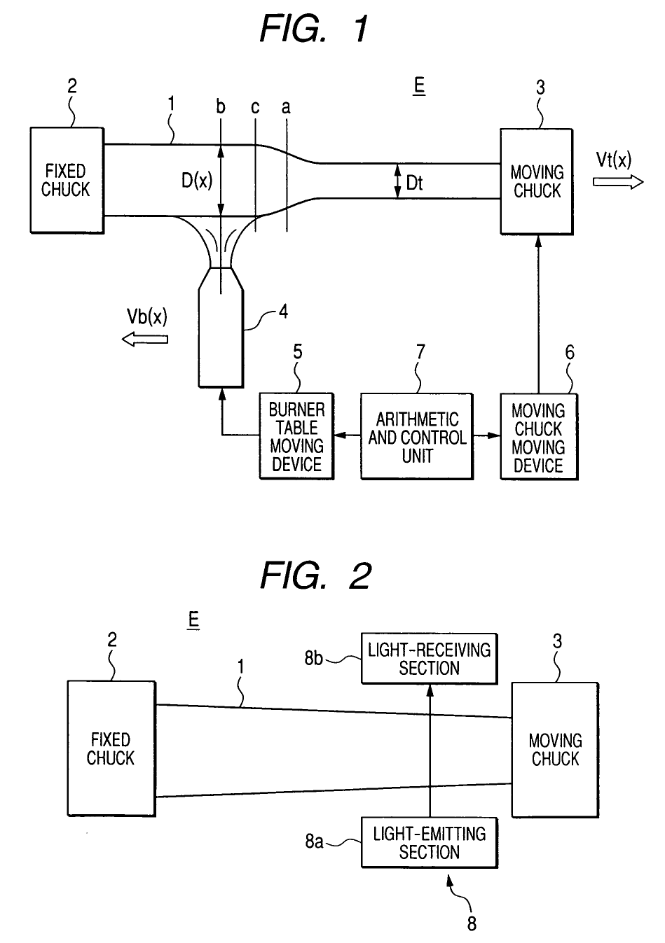

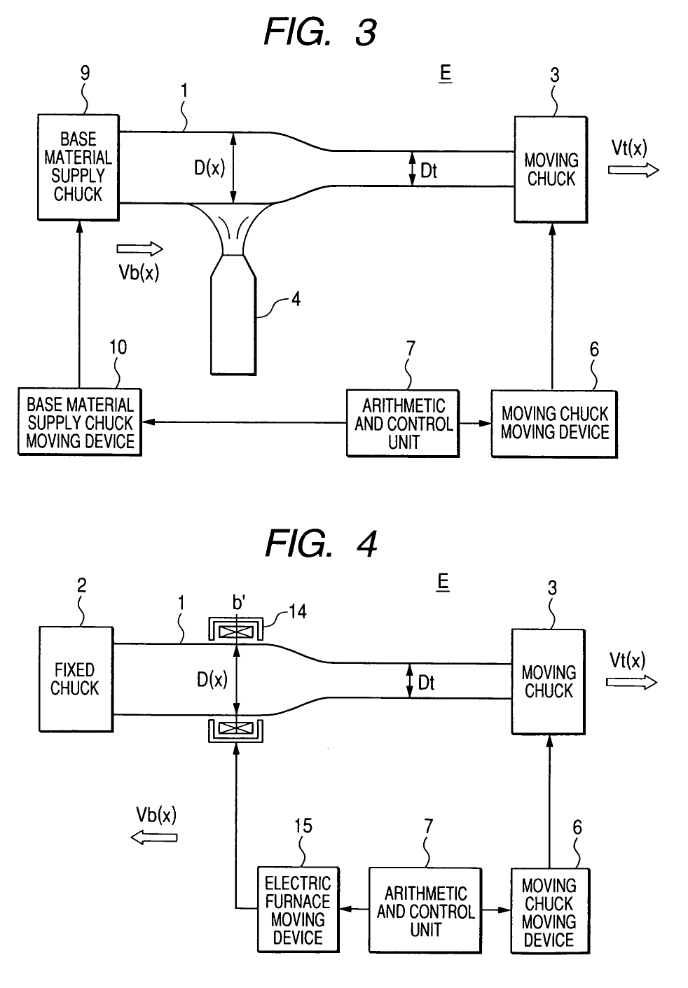

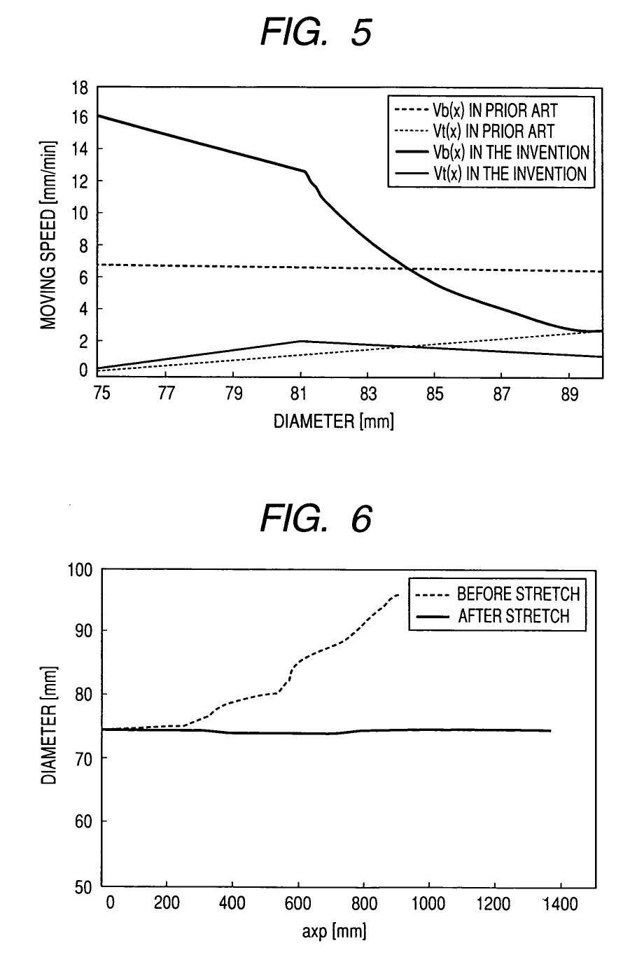

### BRIEF DESCRIPTION OF DRAWING

[FIG. 1] is a schematic diagram showing a structure of an embodiment of the stretching apparatus of the present invention.

[FIG. 2] is a diagram showing a light-emitting section and a light-receiving section of a device for measuring an outer diameter of an optical fiber base material (starting material).

[FIG. 3] is a schematic diagram showing a structure of another example of the stretching apparatus of the present invention.

[FIG. 4] is a schematic diagram showing a structure of still another example of the stretching apparatus of the present invention.

[FIG. 5] is a graph showing relationships of an outer diameter of the optical fiber base material to a moving speed of a heating burner, and to a pulling speed of the optical fiber base material for comparison between the case of the stretching apparatus of the present invention shown in FIG. 1 and the case of the conventional stretching apparatus.

[FIG. 6] is a graph showing variations of the outer diameter of an optical fiber base material in the longitudinal direction before and after the stretching processing by the stretching apparatus of the present invention.

### (EXPLANATIONS OF LETTERS OR NUMERALS)

1 . . . Optical fiber base material
2 . . . Fixed chuck
3 . . . Moving chuck
4 . . . Heating burner
5 . . . Burner table moving device
6 . . . Moving chuck moving device
7 . . . Arithmetic and control unit
8 . . . Outer diameter measuring device
8a . . . Light-emitting section
8b . . . Light-receiving section
9 . . . Base material supply chuck moving device
14 . . . Electric furnace
15 . . . Electric furnace moving device
E . . . Stretching apparatus

### BEST MODES FOR PRACTICING THE INVENTION

In advance of explaining best modes of the present invention by use of the drawings, each of the terms used in this specification is explained below.

The “optical fiber base material” in this specification means a preform having an outer diameter or a diameter of from 60 to 120 mm. However, the method and the apparatus of the present invention can be applied to the stretching of an ingot with a further large diameter, for example, an ingot of the order of up to 200 mm.

The “reference speed” means a relative speed of the heating device relative to the optical fiber base material having a predetermined outer diameter (80 mm, for example) when an amount of heat from the heating device is set constant. This reference speed can be determined empirically if the heating method (heating burner or electric resistance furnace), kinds of used gases in the case of using a burner, variation range of the outer diameter of the processed base material, target stretched outer diameter, etc are determined. As described also in the examples, the reference speed can be set at 6.9 mm/min. empirically, when the outer diameter is from 75 mm to 96 mm in the longitudinal direction, the outer diameter at the stretching starting end is 85 mm, and the target stretched outer diameter is 85 mm.

The “heated position of the optical fiber” means a surface of the base material corresponding to a point at which a center line passing through the center of the nozzle of a heating burner and the axial line of the base material cross at right angles, when the heating device is the heating burner. In a case where the heating device is an electric resistance furnace, a base material surface corresponding to a center portion of the furnace disposed in parallel to the base material in the length direction of the base material is meant.

In the following, embodiments of the present invention are explained by use of the drawings.

FIG. 1 is a diagram schematically showing a structure of an embodiment of the stretching apparatus of an optical fiber base material according to the present invention. In the apparatus of this embodiment, the heating device is a heating burner, and this burner moves. Only one of the gripping devices gripping the both ends of the optical fiber base material moves, and the other is fixed.

As shown in FIG. 1, the stretching apparatus E includes a fixed type scroll chuck (referred to as a fixed chuck hereinafter) 2 gripping one end of the optical fiber base material 1, a moving type scroll chuck (referred to as a moving chuck hereinafter) 3 gripping the other end, a heating burner 4, a burner table moving device (a moving device for the heating burner 4) 5, a moving chuck moving device 6 which moves the moving chuck 3, and an arithmetic and control unit 7 controlling the moving speeds of the burner table moving device 5 and the moving chuck moving device 6. The burner table moving device 5 is configured to move the heating burner 4 such that the moving speed of the heating burner 4 becomes a later-described target moving speed in accordance with a command sent from the arithmetic and control unit 7. The moving chuck moving device 6 is configured to move the moving chuck 3 such that the moving speed of the moving chuck 3 becomes a later-described target pulling speed in accordance with a command sent from the arithmetic and control unit 7.

FIG. 2 is a diagram schematically showing a principle of the method of measuring the outer diameter of the optical fiber base material. As show in FIG. 2, in advance of the stretching processing, the outer diameter of the optical fiber base material 1 is measured over its length direction continuously or at regular intervals by an outer diameter measuring device having a light-emitting section 8a and a light-receiving section 8b, for example, by a laser outer diameter measuring device. The outer diameter measuring device has the light-emitting section 8a and the light-receiving section 8b. The light-emitting section 8a and the light-receiving section 8b are located at opposite positions with respect to the optical fiber base material 1, so that a laser light is transmitted from the light-emitting section 8a and this laser light is received by the light-receiving section 8b.

The stretching processing of the optical fiber base material 1 is performed by heating the periphery of the optical fiber base material 1 by the flame of the heating burner 4 which the burner table moving device 5 moves from the moving chuck 3 side to the fixed chuck 2 side (the second direction), and at the same time, stretching a melted and softened portion of the optical fiber base material 1 by moving the moving chuck 3 by the moving chuck moving device 6 in the direction in which the optical fiber base material is pulled (the first direction). During the heating by the heating burner 4, the optical fiber base material 1 is rotated around the longitudinal axis thereof to uniformly heat a certain periphery of the optical fiber base material 1. For this purpose, the fixed chuck 2 and the moving chuck 3 are configured to rotate in synchronization with each other by a publicly known rotating mechanism (not shown) during the stretching processing.

The relative moving speed of the heating burner 4 relative to the optical fiber base material 1 and the moving speed of the moving chuck 3 are controlled depending on the variation of the outer diameter size of the optical fiber base material 1 over the longitudinal direction in the arithmetic and control unit 7. Accordingly, the outer diameter of the base material is measured over the length direction of the optical fiber base material continuously or at regular intervals by moving the light-transmitting section 8a and the light-receiving section of the outer diameter measuring device from the moving chuck 3 side to the fixed chuck side (or vice versa). In the case of measuring at regular intervals, the intervals are set at the order of from 0.5 mm to 2 mm, and the outer diameter of the optical fiber base material 1 are measures at such intervals. The measured data obtained is inputted to the arithmetic and control unit 7. The arithmetic and control unit 7 calculates the moving speeds of the heating burner 4 and the moving chuck 3 as functions of the heated position x of the optical fiber base material 1 (the distance of the heating burner 4 from the fixed chuck 2, for example) as described later. Incidentally, the arithmetic and control unit 7 stores various kinds of data in advance, and is configured such that the moving speed of the burner and the stretching tension of the moving chuck are automatically obtained through calculation, if the measured results of the outer diameter are inputted as a variable, and predetermined parameters such as kinds of the heating method and kinds of gases used are set in accordance with use conditions when a burner is used.

The heating is performed by the heating burner 4 such that a maximum surface temperature of the optical fiber base material in the heated portion is around 2100 degrees C., preferably within a range of from 2000 degrees C. to 2200 degrees C. Incidentally, a portion of the optical fiber base material 1 being stretched largely changes in diameter, and takes the shape of a neck. The point (a in FIG. 1) at which the diameter changing rate becomes maximum in the neck shape portion lies in a position distant by about 100 mm, for example, in a direction opposite to the moving direction of the heating burner 4 from the center line position (b in FIG. 1) of the heating burner 4. And, the center line position of the heating burner 4 lies in a position distant by about 50 mm, for example, in the moving direction of the heating burner from an immediately-before-stretch position (c in FIG. 1) at which the diameter of the optical fiber base material 1 changes.

As above, since the thermal conductivity of the optical fiber base material is small, it takes time for the heat to be transmitted sufficiently to the core portion thereof, the heating position of the heating burner and the stretch start position do not necessarily coincide with each other

The most principal characteristic of the present invention is in how the relative moving speed of the heating burner relative to the optical fiber base material is determined by the arithmetic and control unit when the amount of heat supplied from the heating device to the optical fiber base material is set constant. In the case of this embodiment, due to the configuration where only the moving chuck of both the chucks at the both ends moves for the stretching, the moving speed of the heating burner is equivalent to the above described relative moving speed. In the present invention, the arithmetic and control unit 7 performs computation and control such that the following expression (1) holds at the time of the measured outer diameter of the optical fiber base material being inputted as data, when the relative moving speed of the heating device relative to the optical fiber base material at a heated position x of the optical fiber base material is Vb(x):
Vb·[Dₘₐₓ/D(x)]²≦Vb(x)≦Vb·[Dₘₐₓ/D(x)]³ (1)
where Vb represents a reference speed, Dₘₐₓ represents a maximum outer diameter of the optical fiber base material, D(x) represents an outer diameter of the optical fiber base material at the heated position x, and Vb(x) has the meaning defined above.
That is, when the power number is n, although n has to satisfy 2≦n≦3, it does not have to be an integer.

Here, as shown in the paragraph of the definition of term, the reference speed Vb is a speed which can be set empirically, if the variation range of the outer diameter of the optical fiber base material, the target stretched outer diameter, etc, are known. As the maximum outer diameter Dₘₐₓ of the optical fiber base material, and the outer diameter D(x) at the heated position of the optical fiber base material, the measured results by the outer diameter measuring device can be inputted. Accordingly, the range of the relative moving speed Vb(x) is automatically determined if the measurement of the outer diameter of the optical fiber base material is performed. Incidentally, the heated position x means the center line position of the heating burner 4 of FIG. 1.

The reasons that the stretching with small outer diameter variation can be done if the relative moving speed Vb(x) is set equal to or larger than Vb·[Dₘₐₓ/D(x)]² and equal to or smaller than Vb·[Dₘₐₓ/D(x)]³ are as follows.

That is, to heat the optical fiber base material to a predetermined stretch enabling temperature, it is necessary to slow the relative moving speed as the cross sectional area increases. On the other hand, to heat the optical fiber base material sufficiently to its core, it is reasonable to set it proportional to the second power of [Dₘₐₓ/D(x)] whose value is determined when the position is determined. Generally speaking, to make the stretching proceed smoothly, it is preferable to perform the stretch while supplying a slightly excessive amount of heat so that the stretching is performed in corelationship with the pulling speed, rather than performing the stretch at a temperature insufficient for the stretching. In this sense, there is no problem in performing the stretch by setting it proportional to the third power of the value of [Dₘₐₓ/D(x)].

However, in the present invention, the value of around the second power of the value of [Dₘₐₓ/D(x)] with respect to the reference speed is used in the case of a relatively thin optical fiber base material, for example, a base material of about 90 mm, or in the case of the difference between the maximum outer diameter and the target stretched outer diameter being in the order of from 5 mm to 10 mm at most. On the other hand, the value of nearly the third power of the above described value is used in the case of a large outer diameter, for example, a base material of about 120 mm, or in the case of the difference between the maximum outer diameter and the target stretched outer diameter exceeding 10 mm.

Meanwhile, it is preferable to set the moving speed of the moving chuck 3 within a range satisfying the relationship of 0.5≦(Dt/Dₘₐₓ)²≦0.99 in view of the limitation of the above described relative moving speed Vb(x), if attention is paid to the moving speed of the chuck (the pulling speed of the base material) in a case where a maximum diameter Dₘₐₓ portion of the optical fiber base material is stretched to reduce by from 1 to 10 mm.

When the flame strength of the heating burner 4 is constant, if the moving speed of the heating burner 4 is set constant as in the conventional stretching apparatuses, the heating to a large diameter portion of the optical fiber base material 1 becomes insufficient, while the heating to a small diameter portion becomes excessive. Therefore, this embodiment is configured to change the moving speed of the heating burner taking account of variation of the outer diameter size or diameter size of the optical fiber base material 1 before stretched as described above.

More specifically, in a position at which the large diameter portion of the optical fiber base material 1 is heated, the moving speed of the heating burner 4, that is, the moving speed of the heated portion of the optical fiber base material is slowed, to prevent insufficient heating to the large diameter portion. This makes it possible to avoid breakage of the optical fiber base material due to insufficient softening of the optical fiber base material, and damage to the stretching equipment. In addition, in a position at which the small diameter portion is heated, the moving speed of the heating burner 4 is quickened, to thereby prevent the small diameter portion from being heated more than necessary.

It is preferable to make the end of a smaller diameter the stretch starting end in a case where an optical fiber base material having a diameter gradually increasing (or decreasing) in the length direction is stretched to reduce hunting in diameter that occurs in early stages of stretching.

In the above described embodiment, the heating burner is moved, however, such a configuration in which the heating burner is fixed, and the optical fiber base material (starting base material) is moved is possible. In this case, as shown in FIG. 3, it is only needed that a movable base material supply chuck 9 is used instead of the fixed chuck 2 of FIG. 1, and a base material supply chuck moving device 10 is used instead of the burner table moving device 5 for moving the heating burner 4. In this case, the pulling speed of the optical fiber base material becomes the difference between the moving speed of the moving chuck 3 and the moving speed of the base material supply chuck 9. At this time, the moving speed of this base material supply chuck becomes the relative moving speed of the heating burner relative to the optical fiber base material. The moving chuck moving device 6 and the base material supply chuck moving device 10 move the moving chuck 3 and the base material supply chuck 10, respectively, so that the moving speed of the heated portion of the optical fiber base material becomes the target moving speed calculated by the arithmetic and control unit 7, and the difference in the moving speed between the moving chuck 3 and the base material supply chuck 9 becomes the target pulling speed calculated by the arithmetic and control unit 7. Although the heating burner is fixed in the example described above, it is a matter of course that, while moving the base material supply chuck 9, the heating device, the heating burner in this case, can be moved as well in this case.

In the stretching apparatuses shown by FIG. 1 and FIG. 3 where a gas burner is used as the heating device, examples of gases usable in the heating device include a combination of a hydrogen gas as the flammable gas and an oxygen gas as the combustion gas, and a combination of a propane gas as the flammable gas and an oxygen gas as the combustion gas.

Although a heating burner is used as the heating device in the above described embodiment, it is possible to use a small-sized electric furnace. In this case, it is only needed to use an electric furnace 14 instead of the heating burner 4, and to use an electric furnace moving device 15 instead of the burner table moving device 5, for example, as shown in FIG. 4. Any electric furnace known in the relevant industry can be used without any specific limitation.

A specific example of the stretch processing of an optical fiber base material by use of the stretching apparatus of the structure of FIG. 1 is explained below.

### EXAMPLE 1

As a starting base material, an optical fiber base material whose outer diameter varies in a range of from 75 mm to 96 mm in the longitudinal direction was used. To the heating burner 4, a hydrogen gas as the flammable gas was supplied at a rate of 390 l (liters)/min., and an oxygen gas as the combustion gas was supplied at a rate of 160 l/min., respectively, and heating control was performed such that a maximum surface temperature at the heated portion was around 2100 degrees C. The portion of the diameter of 85 mm of the optical fiber base material was set as the stretch starting end, and the target stretched outer diameter was set at 75 mm. The reference moving speed Vb of the heating burner was set empirically at 6.9 mm/min.

The target moving speed Vb(x) of the heating burner 4 when the heating burner 4 is in the position (distance from the fixed chuck 2) x was calculated by expression (3) when a diameter of the starting base material at the position x in the longitudinal direction is D(x), and a maximum outer diameter of the starting base material is Dₘₐₓ, and the target stretched outer diameter is Dt. That is, the reference moving speed Vb was changed in proportion to the third power of [Dₘₐₓ/D(x)].

And the moving speed of the moving chuck 3 when the heating burner 4 is at the position x, that is, the target pulling speed Vt(x) of the optical fiber base material was calculated by expression (4)
Vb(x)=Vb·[Dₘₐₓ/D(x)]³ (3)
Vt(x)=Vb(x)·[(D(x)/Dt)²−1] (4)

From expression (4), it is understood that the maximum moving speed Vt(x) of the moving chuck 3 is expressed by expression (5) in a case where the stretch is performed such that the outer diameter of the maximum outer diameter portion of the starting base material is reduced by 5 mm.
Vb(x)·[(Dₘₐₓ/(Dₘₐₓ−5))²−1] (5)

In the present embodiment where the maximum outer diameter of the starting base material is 96 mm, and the stretch is performed such that the outer diameter of the maximum outer diameter portion is reduced by 96−75=21 (mm), the value expressed by expression (6) which is expression (5) multiplied by the square of Dₘₐₓ/D(x) was taken as an upper limit value of Vt(x) in order that the stretching equipment and the starting base material are not applied with an excessive load (tension).
Vb(x)·[(Dₘₐₓ/(Dₘₐₓ−5))²−1]·[Dₘₐₓ/D(x)]² (6)

When the value expressed by expression (4) is larger than the value expressed by expression (6), the target moving speed Vt(x) of the moving chuck 3 was set at the value expressed by expression (6). And in this case, also the target moving speed V of the heating burner 4 was set at the value expressed by expression (7).

$$\begin{matrix}Vb ( x ) = Vt ( x ) / [ {( D ( x ) / Dt )}^{2} - 1 ] \\ = Vt ( x ) \cdot {Dt}^{2} / [ {D ( x )}^{2} - {Dt}^{2} ]\end{matrix} \qquad ( 7 )$$

The moving speed of the heating burner 4 (=Vb(x)), and the moving speed of the moving chuck 3, that is, the pulling speed of the optical fiber base material (=Vt(x)) were as shown in FIG. 5. In the graph of FIG. 5, the vertical axis represents the moving speed (mm/min.) of the heating burner 4, and the horizontal axis represents the outer diameter (mm) of the starting base material. The thick solid line and the thin solid line represent Vb(x) and Vt(x) in the present embodiment, respectively. The stretch was performed also by the conventional method in which the moving speed of the heating device was set constant (6.9 mm/min.). The thick dotted line and the thin dotted line represent Vb(x) and Vt(x) in the prior art stretching apparatus, respectively.

The results of the stretch are shown in FIG. 6. In the graph shown in FIG. 6, the vertical axis represents the outer diameters (mm) of the starting base material (shown by the dotted line in FIG. 6), and the stretched base material obtained by performing the stretch processing, that is, a preform (shown by the solid line in FIG. 6), and the horizontal axis represents the position (mm) in the longitudinal direction of the starting base material or the stretched base material with respect to the thin diameter end as the reference position (mm). The outer diameter variation range in the longitudinal direction of the stretched base material was about 0.1 mm. It has been confirmed that, according to the present invention, when the outer diameter variation range of a starting base material is as large as 21 mm, it can be stretched to a highly uniform outer diameter. Furthermore, it has been also confirmed that the hunting of diameter of the stretched base material in early stage of the stretch, which has often occurred previously, was not present. Accordingly, it was possible to utilize, as a product, the entire preform obtained.

Although a heating burner using a hydrogen gas as the flammable gas, and an oxygen gas as the combustion gas was used as the heating device in the above described embodiment, the same effects can be obtained by using a heating burner using a propane gas as the flammable gas, and using an oxygen gas as the combustion gas, or by using a small-sized electric furnace.

Furthermore, although the relative moving speeds of the heating burner and the moving chuck are changed within a range of from the second power to the third power of the value of [Dₘₐₓ/D(x)] in the above described embodiment, the same effects can be obtained by fixing the heating device, and controlling, with the value of from the second power to the third power of the above described value by the arithmetic and control unit, the supply moving speed of the base material to the heated portion, that is, the moving speed of the base material supply chuck 9 through the base material supply chuck moving device 10.

When the outer diameter difference before and after the stretch is as small as below 5.0 mm, since the effect of the surface area ratio is negligible, a sufficiently accurate stretch is possible even by relatively moving the heating device and the base material in proportion to the second power of the outer diameter ratio.

1. A method of an optical fiber base material comprising the steps of:
gripping both ends in a longitudinal direction of an optical fiber base material by a pair of gripping devices; and
while pulling the optical fiber base material by moving one or both of the pair of the gripping devices in a first direction parallel to the longitudinal direction, moving a heating device relative to the optical fiber base material in a second direction opposite to the first direction;
wherein stretch of the optical fiber base material is performed while changing the relative moving speed Vb(x) in accordance with expression (1):
Vb·[Dₘₐₓ/D(x)]²≦Vb(x)≦Vb·[Dₘₐₓ/D(x)]³ (1)
where Vb represents a reference speed, Dₘₐₓ represents a maximum outer diameter of the optical fiber base material, D(x) represents an outer diameter at a heated position x of the optical fiber base material, and Vb(x) represents a relative moving speed of the heating device relative to the optical fiber base material at the heated position x.

2. The stretching method according to claim 1, wherein the outer diameter of the optical fiber base material is measured over the longitudinal direction thereof in advance of the stretching, and the stretching of the base material is performed while changing the relative moving speed of the heating device relative to the fiber base material on the basis of results of the measurement.

3. The stretching method according to claim 1, wherein a pulling speed of the optical fiber base material is set within a range satisfying the following expression (2)
0.5≦(Dt/Dₘₐₓ)²≦0.99 (2)
where Dt is a target stretched outer diameter, and Dₘₐₓ is the same as the meaning defined in the expression (1).

4. The stretching method according to claim 1, wherein the heating device is a burner, and a point at which a center line of the heating burner nozzle crosses at right angles with an axial line of the optical fiber base material lies in a position distant by 0 to 50 mm in the second direction from a position at which the outer diameter of the optical fiber base material starts changing due to heat application by the heating burner.

5. The stretching method according to claim 4, wherein a combustion gas used in the heating device is oxygen, and a flammable gas is hydrogen or propane.

6. The stretching method according to claim 1, wherein the heating device is an electric furnace, the electric furnace is disposed in parallel with the longitudinal direction of the optical fiber base material, and a point at which a center of the heating burner in the longitudinal direction crosses at right angles with an axial line of the optical fiber base material lies in a position distant by 0 to 50 mm in the second direction from a position at which the outer diameter of the optical fiber base material starts changing due to heat application by the electric furnace.

7. The stretching method according to claim 1, wherein the relative speed is a relative speed created by fixing one of the pair of the gripping devices, and moving the heating device in the second direction.

8. The stretching method according to claim 1, wherein the relative speed is a relative speed created by moving both of the pair of the gripping devices at different speeds in the first direction, and fixing the heating device.

9. The stretching method according to claim 1, wherein the relative speed is a relative speed created by moving both of the pair of the gripping devices at different speeds in the first direction, and moving the heating device in the second direction.

10. A stretching apparatus of an optical fiber base material comprising:
a pair of gripping devices for gripping both ends in a longitudinal direction of the optical fiber base material;
a heating device for heating a periphery of the optical fiber base material;
a gripping device moving device for moving one or both of the pair of the gripping devices to pull the optical fiber base material in a first direction parallel to the longitudinal direction; and
an arithmetic and control unit;
wherein the arithmetic and control unit performs an arithmetic and control with a target moving speed at a heated position of the optical fiber base material being set to the relative moving speed of the heating device relative to the optical fiber base material, and when the relative moving speed is Vb(x), Vb(x) is changed in accordance with expression (1):
Vb·[Dₘₐₓ/D(x)]²≦Vb(x)≦Vb·[Dₘₐₓ/D(x)]³ (1)
where Vb represents a reference speed, Dₘₐₓ represents a maximum outer diameter of the optical fiber base material, D(x) represents an outer diameter of the optical fiber base material at the heated position x, and Vb(x) represents the relative moving speed of the heating device relative to the optical fiber base material at the heated position x.

11. The stretching apparatus according to claim 10, further comprising an outer diameter measuring device for measuring an outer diameter at each position in the longitudinal direction of the optical fiber base material.

12. The stretching apparatus according to claim 10, wherein the arithmetic and control unit also computes a pulling speed of the optical fiber on the basis of the outer diameter at each position in the longitudinal direction of the optical fiber base material, and the gripping device moving device moves one or both of the pair of the gripping devices on the basis of the results.

13. The stretching apparatus according to claim 12, wherein the pulling speed of the optical fiber is set within a range satisfying the following expression (2):
0.5≦(Dt/Dₘₐₓ)²≦0.99 (2)
where Dt is a target stretched outer diameter, and Dₘₐₓ is the same as the meaning defined in the expression (1).

14. The stretching apparatus according to claim 10, wherein, in a case where the both of the pair of the gripping devices are pulled, the gripping devices at the both ends in the longitudinal direction are moved by the gripping device moving device at different speeds so that the optical fiber base material is pulled in the first direction.

15. The stretching apparatus according to claim 10, wherein the heating device is a heating burner.

16. The stretching apparatus according to claim 15, wherein the heated position is at a position distant by 0 to 50 mm from a position at which the outer diameter of the optical fiber base material starts changing due to heat application by the heat burner.

17. The stretching apparatus according to claim 15, wherein a combustion gas used in the heating device is oxygen, and a flammable gas is hydrogen or propane.

18. The stretching apparatus according to claim 10, wherein the heating device is an electric resistor furnace.

19. The stretching apparatus according to claim 10, further comprising a heating device moving device for moving the heating device in a second direction opposite to the first direction.
